(19) United States
(12) Patent Application Publication
(10) Pub. No.: US 2026/0368659 A1
(43) Pub. Date: Nov. 19, 2026

(54) Decomposition-Based Multi-Objective Reinforcement Learning Method for Job Shop Scheduling

(71) Applicant: Beijing University of Technology, Beijing (CN)

(72) Inventors: Fangyu Li, Beijing (CN); Jiarong Du, Beijing (CN); Ruichong Ma, Beijing (CN); Jingjing Wang, Beijing (CN); Honggui Han, Beijing (CN)

(21) Appl. No.: 19/564,720

(22) Filed: Mar. 12, 2026

(30) Foreign Application Priority Data
May 14, 2025 (CN) 202510621245.4

(51) Int. Cl. G06Q 10/0631; G06N 3/092

(52) U.S. Cl. CPC G06Q 10/06311; G06N 3/092

(57) ABSTRACT

This invention addresses the problems of difficult balance, unstable strategies and low optimization efficiency in multi-objective optimization under complex scheduling environments, and proposes a job-shop scheduling method based on decomposed multi-objective reinforcement learning. This method dynamically adjusts the weight configuration, uses the hyperbolic tangent model to predict the target values of candidate weights, combines regularization to reduce model complexity, introduces comprehensive evaluation indicators to screen the solution set, and realizes adaptive learning of features and stable update of strategies. By optimizing the weight selection and strategy update mechanism, it can efficiently balance multiple conflicting objectives, improve the efficiency and accuracy of scheduling decisions, reduce energy consumption, and enhance production efficiency. This invention's method can effectively solve the multi-objective job-shop scheduling problem in industrial automation and intelligent manufacturing processes, providing technical support for production optimization.

### TECHNICAL FIELD

Based on the decomposition-based multi-objective reinforcement learning algorithm, the present invention establishes a job shop scheduling method. By utilizing policy optimization and weight adjustment mechanisms, the method achieves balanced optimization of multiple conflicting objectives and efficient decision-making in complex scheduling environments. Through dynamic adjustment of weight configurations, the method improves the efficiency of multi-objective optimization and the quality of decision-making. In actual production and intelligent manufacturing processes, the method can effectively solve multi-objective scheduling problems, improve production efficiency, reduce energy consumption, and realize intelligent and automated optimized scheduling, providing technical support for the fields of industrial automation and intelligent manufacturing.

### BACKGROUND ART

Job shop scheduling problems are highly complex in actual production processes, usually involving multiple mutually conflicting objectives such as minimizing makespan and reducing machine energy consumption. Conflicts between these objectives make solving scheduling problems more challenging. Traditional single-objective optimization methods are difficult to balance multiple objectives simultaneously, leading to unsatisfactory optimization results and failure to meet actual production needs.

In recent years, multi-objective reinforcement learning has received widespread attention as an effective multi-objective optimization method. Multi-objective reinforcement learning achieves synchronous optimization of multiple objectives by learning policies to trade off between different objectives. However, existing multi-objective reinforcement learning methods often face problems such as objective conflicts, policy instability, and low optimization efficiency when dealing with complex scheduling problems. In addition, weight selection and policy update mechanisms play a key role in multi-objective optimization. How to effectively select weights and stably update policies has become the key to improving the performance of multi-objective reinforcement learning. Furthermore, dynamic environmental changes and multi-objective conflicts in complex scheduling problems make existing optimization methods difficult to adapt quickly and make efficient decisions, which further limits their application in actual production. While considering multiple optimization indicators comprehensively, existing methods often ignore the stability and robustness in the policy learning process, resulting in poor performance in practical applications. To overcome these problems, there is an urgent need for a new method to improve the performance of multi-objective reinforcement learning in complex scheduling problems through optimizing weight selection and policy update mechanisms, and to realize efficient decision-making and policy learning in multi-objective optimization tasks.

The present invention solves the problems of low efficiency and policy instability of existing multi-objective reinforcement learning methods in the multi-objective optimization process by introducing a decomposition-based weight selection strategy. This method achieves efficient multi-objective optimization and decision-making in complex scheduling problems, providing effective technical support for industrial automation and intelligent manufacturing. By improving the algorithm, the method can adapt to the needs in practical applications and improve the overall performance and reliability of the system.

### SUMMARY OF THE INVENTION

The present invention provides a decomposition-based multi-objective reinforcement learning method for job shop scheduling. By introducing indicators such as information entropy, hypervolume, and sparsity, the method optimizes the weight selection and policy update mechanisms in the multi-objective reinforcement learning model, realizing efficient decision-making and policy learning in multi-objective optimization tasks. When dealing with complex scheduling problems, the method can effectively balance multiple conflicting objectives and improve optimization efficiency and decision quality. Specifically, the present invention includes the following steps:

### (1) Collect Physical Data of the Job Shop

Use machine operation state sensors to collect machine idle/busy status and available time of machine resources for the next operation. Use job progress detection sensors to collect job assignability, remaining time of the current operation, percentage of completed operations, remaining time for job completion, and idle time after the last completed operation. The collected data is preprocessed by distributed data acquisition terminals and transmitted to the data analysis module of the industrial server via field bus. The data analysis module standardizes the data into a (J×7)-dimensional matrix, where J is the number of jobs, and each row contains 7 attributes corresponding to the above-collected physical data. Use energy consumption metering sensors to collect machine power consumption data.

### (2) Construct a Job Shop Scheduling Reinforcement Learning Model

Use the aforementioned (J×7)-dimensional matrix as the state space s of the reinforcement learning algorithm. Define the action space a of the reinforcement learning algorithm as a one-dimensional vector containing 2 physical action instructions, which are generated by the scheduling execution module of the industrial server and issued through the industrial communication module: 1) Assign the job to a machine, or choose to skip the current scheduling operation and proceed to the next time step; 2) Select the processing speed level of the assigned operation.

Design the comprehensive optimization objective as a reward function reflecting two mutually exclusive goals—minimizing makespan and minimizing energy consumption—through a decomposition approach. The reward for minimizing makespan R_{MS} is obtained by calling the processing time Cᵢⱼₕ of operation h of job jon machine i recorded by the machine controller, and the idle time idleᵢ of machine i after job assignment collected by the machine state sensor. The specific formula is as follows:

$${R}_{MS} = \frac{1}{{C}_{ijh} \cdot {e}^{- \frac{0.1}{{p}_{ijh}}}} - {idle}_{i} \qquad ( 1 )$$

The reward for minimizing energy consumption R_{E} is obtained by calling the power consumption rate pᵢⱼₕ of operation h of job j on machine i collected by the energy consumption metering sensor, and Cᵢⱼₕ recorded by the machine controller. The specific formula is as follows:

$${R}_{E} = {C}_{ijh} \cdot {p}_{ijh}^{2} \qquad ( 2 )$$

### (3) Prediction-and-Selection-Based Weight Adjustment

The model training module of the industrial server initializes 6 policy-weight pairs [p, w] to form a policy-weight set [symbol] , which is stored in the parameter configuration unit of the local storage module. The specific formula is as follows:

[symbol]

={[p₁,w₁],[p₂,w₂], . . . ,[p₆,w₆]} (3)

Wherein, p is a single neural network policy model trained based on the Proximal Policy Optimization (PPO) algorithm, deployed in the model training module of the industrial server. The input of each policy p is the environmental state s, and the output is the probability distribution of action a. Network parameters are adjusted to maximize the long-term reward function R(s, a). w=[ω₁, ω₂] is a weight set. During reinforcement learning training, the reward functions described in Formulas (1) and (2) are combined in a linear weighting manner according to weights ω1 and ω2 in the weight set w. The specific formula is as follows:

R(s,a)=ω₁R_{MS}+ω₁ RE (4)

When the weight update moment is reached, adaptively update each weight. The update method includes the following sub-steps:

### \textcircled{1} Generate Candidate Weights

The parameter configuration unit sets a range according to the current weight θ=arccos (ω₁)±45°, and generates weight vectors at intervals of 2°: w={[cos (θ₁), sin (θ₂)], [cos (θ₁), sin (θ₂)], . . . , [cos (on), sin (on)]}. It screens non-negative weights to add to the candidate policy-weight set [symbol] and synchronously stores them in the local storage module.

### \textcircled{2} Predict Target Values

Adopt a regularization-based hyperbolic tangent fitting method to model the variation law of target values corresponding to candidate weights, and obtain model parameters through least squares optimization. First, normalize the candidate weights so that the sum of each component is 1. Then, obtain target value data, candidate weight data, and target variation data through the distributed data acquisition terminal, and transmit these data to the data analysis module to construct training samples {xᵢ, yᵢ}, where xᵢ denotes the value of the candidate weight in a single target dimension, and yᵢ denotes the corresponding target variation. Meanwhile, the data analysis module generates a sample weight factor wᵢ through a Gaussian function, where the default value of the scale parameter σ of the Gaussian function is 0.03, and the initial search threshold is 0.1. If the collected valid data points are insufficient, gradually increase the search threshold and adjust the σ value until a sufficient number of valid data are obtained, and store the data in the local storage module.

The model training module calls the training samples in the local storage module to construct the hyperbolic tangent model:

$$f ( x ; A , a , b , c ) = \frac{A ( {e}^{a ( x - b )} - 1 )}{{e}^{a ( x - b )} + 1} + c \qquad ( 5 )$$

Wherein, A, a, b, and c are model parameters, and the initial parameter vector is set to [1, 1, 1, 1]. Define the loss function as:

$${L}_{hb} = {\sum }_{i} {[ f ( {x}_{i} ; A , a , b , c ) - {y}_{i} ]}^{2} \cdot {w}_{i} + β \cdot \frac{{A}^{2} + {a}^{2} + {b}^{2} + {c}^{2}}{\vert r \vert} \qquad ( 6 )$$

Wherein, β is the regularization coefficient with a default value of 0.01; |r| denotes the norm of the residual vector. The parameter boundaries are set as follows: A ∈ [0, A_{ub}], where A_{ub} is the difference between the maximum and minimum values of all yᵢ, clipped to the range of 1 to 500; a ∈ [0,20]; b ∈ [−5,5]; and c ∈ [−500,500].

Adopt the least squares optimization algorithm to minimize the loss function L_{hb} using the soft L1 loss function and a scaling factor f_{scale}=20. Update parameters using the gradient descent method, and the update formula is as follows:

$$θ ← θ - η \frac{\partial {L}_{hb}}{\partial θ} , θ ∈ \{ A , a , b , c \} \qquad ( 7 )$$

Wherein, the learning rate η has a default value of 1×10⁻³. The iteration continues until the change in the loss function is less than the preset threshold ∈=10⁻⁶ or the maximum number of iterations Nₘₐₓ=1000 is reached, and finally the optimal parameter combination (A*, a*, b*, c*) is obtained. Store the optimal parameter model in the local storage module.

The model training module calls the optimal parameter model f(x; A*, a*, b*, c*) to predict the target variation of the test weight, and adds it to the target value collected in real time by the distributed data acquisition terminal to obtain the predicted target value Ôₜ₊₁ of the candidate weight in the next round, which is stored in the local storage module.

### \textcircled{3} Select Optimal Policy-Weight Pairs

The data analysis module calls the candidate policy-weight set [symbol] and the predicted target value Ôₜ₊₁ in the local storage module to calculate the comprehensive metric [symbol] ( [symbol] ):

[symbol]

( [symbol] )=HV( [symbol] )+400·IE( [symbol] )−S( [symbol] ) (8)
Wherein, HV( [symbol] ) is the hypervolume indicator of the quality of the candidate set [symbol] ; IE( [symbol] ) is the information entropy indicator of the uniformity of the candidate set [symbol] ; S( [symbol] ) is the sparsity indicator of the sparsity of the candidate set [symbol] . Their calculation formulas are as follows:

$$HV ( 𝒞𝒮 ) = {\sum }_{k = 1}^{\vert 𝒞𝒮 \vert - 1} {\prod }_{l = 1}^{M} ( {\tilde{𝒞}}_{l}^{ref} - {\tilde{𝒞}}_{l} ( k ) ) \qquad ( 9 )$$

Wherein, | [symbol] | is the number of policy-weight pairs in the candidate set [symbol] ; M is the number of targets;

$${\tilde{𝒞}}_{l}^{ref}$$

is the component of the reference point (0,0) in the l-th target; [symbol] (k) is the value of the k-th candidate solution in the l-th target component.

$$IE ( 𝒞𝒮 ) = - {\sum }_{l = 1}^{\vert 𝒞𝒮 \vert - 1} p ( {\tilde{𝒞}}_{l} ) log p ( {\tilde{𝒞}}_{l} ) \qquad ( 10 )$$

Wherein, p( [symbol] ) denotes the proportion of target values in the candidate set [symbol] that fall into the l-th segment. The target value range is divided into 10 equal parts, and the number of policies in each part is counted to obtain the proportion of each part.

$$S ( 𝒞𝒮 ) = \frac{1}{\vert 𝒞𝒮 \vert - 1} {\sum }_{k = 1}^{\vert 𝒞𝒮 \vert - 1} {\prod }_{l = 1}^{M} {( {\tilde{𝒞}}_{l} ( k ) - {\tilde{𝒞}}_{l} ( k + 1 ) )}^{2} \qquad ( 11 )$$

Wherein, [symbol] (k+1) is the value of the (k+1)-th candidate solution in the l-th target component.

The data analysis module sorts [symbol] in descending order of the comprehensive metric [symbol] ( [symbol] ), and selects the top 18 candidate pairs to form the initial candidate set. From the 18 candidate policy-weight pairs, select the top 6 pairs with the highest mutual information I(W; O) between the candidate weight vector and the target vector to form the final policy-weight set. The calculation formula is as follows:

$$I ( W ; O ) = {\sum }_{i = 1}^{6} p ( {w}_{i} , {O}_{i} ) log \frac{p ( {w}_{i} , {O}_{i} )}{p ( {w}_{i} ) p ( {O}_{i} )} \qquad ( 12 )$$

Wherein, W=[w₁, w₂, . . . , w₆] denotes each candidate weight vector; O=[O₁, O₂, . . . , O₆] denotes the target vector. Store the final policy-weight set [symbol] in the local storage module.

### (4) Model Training and Optimization

The parameter configuration unit initializes the 6 weight sets w at intervals of 0.2 as w₁={[1,0]}, w₂={[0.8,0.2]}, w₃={[0.6,0.4]}, w₄={[0.4,0.6]}, w₅={[0.2,0.8]}, w₆={[0,1]}, and forms the policy-weight set [symbol] with randomly initialized policy models p.

In the pre-training phase, the model training module performs 20 rounds of reinforcement learning training on each policy p using fixed weights. The intermediate data of each round of training is written into the local storage module in real time, and the training instructions are issued to the machine controller through the industrial communication module to verify the action execution effect.

In the main training phase, the model training module performs reinforcement learning training on each policy p in the policy-weight set [symbol] , and dynamically updates the policy-weight set every 10 rounds by calling the method described in step (3) through the industrial communication module to adjust the weights used in the reward function of each policy.

When the total number of training rounds reaches 100, the model training module extracts the 100th round of training data from the local storage module, screens policies with an average reward not less than 90% of the historical maximum reward, and forms the final policy set p=[p₁, p₂, . . . , p_{q}], where q is the number of finally obtained policies. Store the policy set in the policy library of the industrial server, interface with the scheduling execution module to generate scheduling instructions, and issue them to the machine controller through the industrial communication module to execute job shop scheduling operations.

### Creative Points of the Present Invention

(1) The present invention introduces the information entropy indicator for the weight selection strategy, which can effectively evaluate the diversity and information richness of the candidate weight set. By using information entropy, weight samples containing rich unknown information are selected, which enhances the exploration ability and generalization performance of the model in the multi-objective optimization process, improves optimization efficiency, and solves the problem of insufficient information utilization in the weight selection process of existing methods.

(2) The present invention adopts a mutual information screening mechanism to evaluate the correlation between candidate weights and optimization objectives, and selects the weight set with the highest mutual information as the final optimization direction. This screening method ensures a high degree of correlation between weight selection and optimization objectives, improves the accuracy of decision-making and the effectiveness of optimization, overcomes the shortcomings of existing multi-objective reinforcement learning methods in objective correlation evaluation, and further enhances the stability and robustness of policy updates.

### BRIEF DESCRIPTION OF THE DRAWINGS

FIG. 1 is a Pareto front diagram obtained by training for an example of job shop scheduling according to the present invention.

FIG. 2 is a schematic diagram illustrating the actual interaction process between the sensor of the present invention and the scheduling environment.

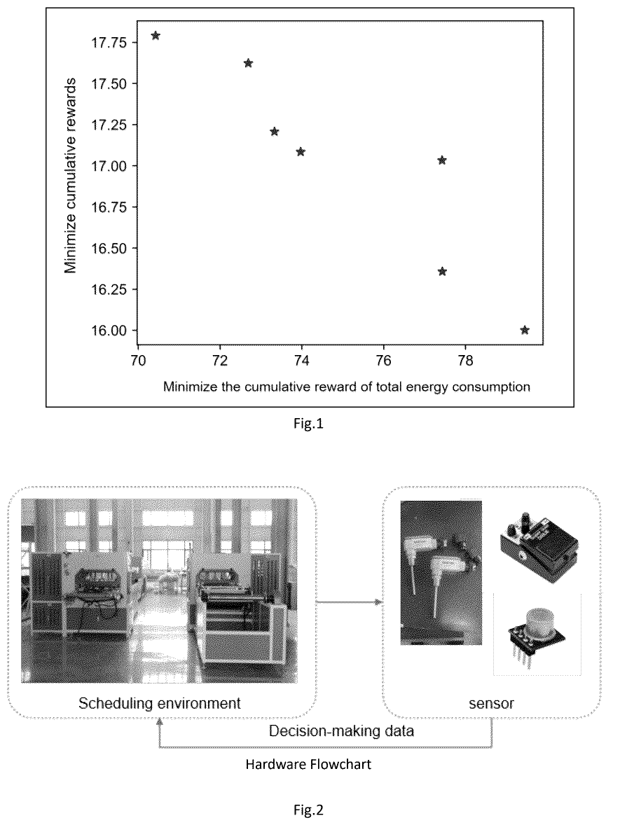

### DETAILED IMPLEMENTATION

1. A decomposition-based multi-objective reinforcement learning method for job shop scheduling is characterized by constructing a job shop scheduling reinforcement learning model, performing model training and optimization based on prediction-and-selection-based weight adjustment, including the following steps:

### (1) Collect Physical Data of the Job Shop

Use machine operation state sensors to collect machine idle/busy status and available time of machine resources for the next operation. Use job progress detection sensors to collect job assignability, remaining time of the current operation, percentage of completed operations, remaining time for job completion, and idle time after the last completed operation. The collected data is preprocessed by distributed data acquisition terminals and transmitted to the data analysis module of the industrial server via field bus. The data analysis module standardizes the data into a (J×7)-dimensional matrix, where J is the number of jobs, and each row contains 7 attributes corresponding to the above-collected physical data. Use energy consumption metering sensors to collect machine power consumption data.

### (2) Construct a Job Shop Scheduling Reinforcement Learning Model

Use the aforementioned (J×7)-dimensional matrix as the state space s of the reinforcement learning algorithm. Define the action space a of the reinforcement learning algorithm as a one-dimensional vector containing 2 physical action instructions, which are generated by the scheduling execution module of the industrial server and issued through the industrial communication module: 1) Assign the job to a machine, or choose to skip the current scheduling operation and proceed to the next time step; 2) Select the processing speed level of the assigned operation.

Design the comprehensive optimization objective as a reward function reflecting two mutually exclusive goals—minimizing makespan and minimizing energy consumption—through a decomposition approach. The reward for minimizing makespan R_{MS} is obtained by calling the processing time Cᵢⱼₕ of operation h of job jon machine i recorded by the machine controller, and the idle time idleᵢ of machine i after job assignment collected by the machine state sensor. The specific formula is as follows:

$${R}_{MS} = \frac{1}{{C}_{ijh} \cdot {e}^{- \frac{0.1}{{p}_{ijh}}}} - {idle}_{i} \qquad ( 1 )$$

The reward for minimizing energy consumption R_{E} is obtained by calling the power consumption rate pᵢⱼₕ of operation h of job j on machine i collected by the energy consumption metering sensor, and Cᵢⱼₕ recorded by the machine controller. The specific formula is as follows:

$${R}_{E} = {C}_{ijh} \cdot {p}_{ijh}^{2} \qquad ( 2 )$$

### (3) Prediction-and-Selection-Based Weight Adjustment

The model training module of the industrial server initializes 6 policy-weight pairs [p, w] to form a policy-weight set [symbol] , which is stored in the parameter configuration unit of the local storage module. The specific formula is as follows:

[symbol]

={[p₁,w₁],[p₂,w₂], . . . ,[p₆,w₆]} (3)
Wherein, p is a single neural network policy model trained based on the Proximal Policy Optimization (PPO) algorithm, deployed in the model training module of the industrial server. The input of each policy p is the environmental state s, and the output is the probability distribution of action a. Network parameters are adjusted to maximize the long-term reward function R(s, a). w=[ω₁, ω₂] is a weight set. During reinforcement learning training, the reward functions described in Formulas (1) and (2) are combined in a linear weighting manner according to weights ω₁ and ω₂ in the weight set w. The specific formula is as follows:

R(s,a)=ω₁R_{MS}+ω₁R_{E} (4)

When the weight update moment is reached, adaptively update each weight. The update method includes the following sub-steps:

### 4 Generate Candidate Weights

The parameter configuration unit sets a range according to the current weight θ=arccos(ω₁)±45°, and generates weight vectors at intervals of 2°: w={[cos (θ₁), sin (θ₂)], [cos (θ₁), sin (θ₂)], . . . , [cos (θₙ), sin (θₙ)]}. It screens non-negative weights to add to the candidate policy-weight set [symbol] and synchronously stores them in the local storage module.

### \textcircled{5} Predict Target Values

Adopt a regularization-based hyperbolic tangent fitting method to model the variation law of target values corresponding to candidate weights, and obtain model parameters through least squares optimization. First, normalize the candidate weights so that the sum of each component is 1. Then, obtain target value data, candidate weight data, and target variation data through the distributed data acquisition terminal, and transmit these data to the data analysis module to construct training samples {xᵢ, yᵢ}, where xᵢ denotes the value of the candidate weight in a single target dimension, and yᵢ denotes the corresponding target variation. Meanwhile, the data analysis module generates a sample weight factor wᵢ through a Gaussian function, where the default value of the scale parameter σ of the Gaussian function is 0.03, and the initial search threshold is 0.1. If the collected valid data points are insufficient, gradually increase the search threshold and adjust the σ value until a sufficient number of valid data are obtained, and store the data in the local storage module.

The model training module calls the training samples in the local storage module to construct the hyperbolic tangent model:

$$f ( x ; A , a , b , c ) = \frac{A ( {e}^{a ( x - b )} - 1 )}{{e}^{a ( x - b )} + 1} + c \qquad ( 5 )$$

Wherein, A, a, b, and c are model parameters, and the initial parameter vector is set to [1, 1, 1, 1]. Define the loss function as:

$${L}_{hb} = {\sum }_{i} {[ f ( {x}_{i} ; A , a , b , c ) - {y}_{i} ]}^{2} \cdot {w}_{i} + β \cdot \frac{{A}^{2} + {a}^{2} + {b}^{2} + {c}^{2}}{\vert r \vert} \qquad ( 6 )$$

Wherein, β is the regularization coefficient with a default value of 0.01; |r| denotes the norm of the residual vector. The parameter boundaries are set as follows: A ε [0, A_{ub}], where A_{ub} is the difference between the maximum and minimum values of all yᵢ, clipped to the range of 1 to 500; a ∈ [0,20]; b E [−5,5]; and c ∈ [−500,500].

Adopt the least squares optimization algorithm to minimize the loss function L_{hb} using the soft L1 loss function and a scaling factor f_{scale}=20. Update parameters using the gradient descent method, and the update formula is as follows:

$$θ ← θ - η \frac{\partial {L}_{hb}}{\partial θ} , θ ∈ \{ A , a , b , c \} \qquad ( 7 )$$

Wherein, the learning rate n has a default value of 1×10⁻³. The iteration continues until the change in the loss function is less than the preset threshold ∈=10⁻⁶ or the maximum number of iterations Nₘₐₓ=1000 is reached, and finally the optimal parameter combination (A*, a*, b*, c*) is obtained. Store the optimal parameter model in the local storage module.

The model training module calls the optimal parameter model f(x; A*, a*, b*, c*) to predict the target variation of the test weight, and adds it to the target value collected in real time by the distributed data acquisition terminal to obtain the predicted target value Ôₜ₊₁ of the candidate weight in the next round, which is stored in the local storage module.

### \textcircled{6} Select Optimal Policy-Weight Pairs

The data analysis module calls the candidate policy-weight set [symbol] and the predicted target value Ôₜ₊₁ in the local storage module to calculate the comprehensive metric [symbol] ( [symbol] ):

[symbol]

( [symbol] )=HV( [symbol] )+400·IE( [symbol] )−S( [symbol] ) (8)

Wherein, HV( [symbol] ) is the hypervolume indicator of the quality of the candidate set [symbol] ; IE( [symbol] ) is the information entropy indicator of the uniformity of the candidate set [symbol] ; S( [symbol] ) is the sparsity indicator of the sparsity of the candidate set [symbol] . Their calculation formulas are as follows:

$$HV ( 𝒞𝒮 ) = {\sum }_{k = 1}^{\vert 𝒞𝒮 \vert - 1} {\prod }_{l = 1}^{M} ( {\tilde{𝒞}}_{l}^{ref} - {\tilde{𝒞}}_{l} ( k ) ) \qquad ( 9 )$$

Wherein, | [symbol] | is the number of policy-weight pairs in the candidate set [symbol] ; M is the number of targets;

$${\tilde{𝒞}}_{l}^{ref}$$

is the component of the reference point (0,0) in the l-th target; [symbol] (k) is the value of the k-th candidate solution in the l-th target component.

$$IE ( 𝒞𝒮 ) = - {\sum }_{l = 1}^{\vert 𝒞𝒮 \vert - 1} p ( {\tilde{𝒞}}_{l} ) log p ( {\tilde{𝒞}}_{l} ) \qquad ( 10 )$$

Wherein, p( [symbol] ) denotes the proportion of target values in the candidate set [symbol] that fall into the l-th segment. The target value range is divided into 10 equal parts, and the number of policies in each part is counted to obtain the proportion of each part.

$$S ( 𝒞𝒮 ) = \frac{1}{\vert 𝒞𝒮 \vert - 1} {\sum }_{k = 1}^{\vert 𝒞𝒮 \vert - 1} {\sum }_{l = 1}^{M} {( {\tilde{𝒞}}_{l} ( k ) - {\tilde{𝒞}}_{l} ( k + 1 ) )}^{2} \qquad ( 11 )$$

Wherein, [symbol] (k+1) is the value of the (k+1)-th candidate solution in the l-th target component.

The data analysis module sorts [symbol] in descending order of the comprehensive metric [symbol] ( [symbol] ), and selects the top 18 candidate pairs to form the initial candidate set. From the 18 candidate policy-weight pairs, select the top 6 pairs with the highest mutual information I(W; O) between the candidate weight vector and the target vector to form the final policy-weight set. The calculation formula is as follows:

$$I ( W ; O ) = {\sum }_{i = 1}^{6} p ( {w}_{i} , {O}_{i} ) log \frac{p ( {w}_{i} , {O}_{i} )}{p ( {w}_{i} ) p ( {O}_{i} )} \qquad ( 12 )$$

Wherein, W=[w₁, w₂, . . . , w₆] denotes each candidate weight vector; O=[O₁, O₂, . . . , O₆] denotes the target vector. Store the final policy-weight set [symbol] in the local storage module.

### (4) Model Training and Optimization

The parameter configuration unit initializes the 6 weight sets w at intervals of 0.2 as w₁={[1,0]}, w₂={[0.8,0.2]}, w₃={[0.6,0.4]}, w₄={[0.4,0.6]}, W₅={[0.2,0.8]}, w₆={[0,1]}, and forms the policy-weight set [symbol] with 6 randomly initialized policy models p.

In the pre-training phase, the model training module performs 20 rounds of reinforcement learning training on each policy p using fixed weights. The intermediate data of each round of training is written into the local storage module in real time, and the training instructions are issued to the machine controller through the industrial communication module to verify the action execution effect.

In the main training phase, the model training module performs reinforcement learning training on each policy p in the policy-weight set [symbol] , and dynamically updates the policy-weight set every 10 rounds by calling the method described in step (3) through the industrial communication module to adjust the weights used in the reward function of each policy.

When the total number of training rounds reaches 100, the model training module extracts the 100th round of training data from the local storage module, screens policies with an average reward not less than 90% of the historical maximum reward, and forms the final policy set p=[p₁, p₂, . . . , p_{q}], where q is the number of finally obtained policies. Store the policy set in the policy library of the industrial server, interface with the scheduling execution module to generate scheduling instructions, and issue them to the machine controller through the industrial communication module to execute job shop scheduling operations.

What is claimed is:

1. A decomposition-based multi-objective reinforcement learning method for job shop scheduling, characterized by collecting physical data of the job shop, constructing a job shop scheduling reinforcement learning model, and performing model training and optimization based on prediction-and-selection-based weight adjustment, comprising the following steps:
(1) Collect physical data of the job shop
Use machine operation state sensors to collect machine idle/busy status and available time of machine resources for the next operation. Use job progress detection sensors to collect job assignability, remaining time of the current operation, percentage of completed operations, remaining time for job completion, and idle time after the last completed operation. The collected data is preprocessed by distributed data acquisition terminals and transmitted to the data analysis module of the industrial server via field bus. The data analysis module standardizes the data into a (J×7)-dimensional matrix, where J is the number of jobs, and each row contains 7 attributes corresponding to the above-collected physical data. Use energy consumption metering sensors to collect machine power consumption data.
(2) Construct a job shop scheduling reinforcement learning model
Define the state space s as a (J×7)-dimensional matrix, where J is the number of jobs. Each row includes 7 attributes: job assignability, remaining time of the current operation, percentage of completed operations, remaining time for job completion, available time of machine resources for the next operation, idle time after the last completed operation, and cumulative job-level idle time.
Define the action space a as a one-dimensional vector containing two actions: 1) Assign the job to a machine, or choose to skip the current scheduling operation and proceed to the next time step; 2) Select the processing speed level of the assigned operation.
Design the comprehensive optimization objective as a reward function reflecting two mutually exclusive goals, minimizing makespan and minimizing energy consumption, through a decomposition approach. The reward for minimizing makespan R_{MS} is represented by the processing time of each operation, and the reward for minimizing energy consumption R_{E} is represented by the square of energy consumption. The specific formulas are as follows:
$${R}_{MS} = \frac{1}{{C}_{ijh} \cdot {e}^{- \frac{0.1}{{p}_{ijh}}}} - {idle}_{i} \qquad ( 1 )$$
$${R}_{E} = {C}_{ijh} \cdot {p}_{ijh}^{2} \qquad ( 2 )$$
Wherein, Cᵢⱼₕ denotes the processing time of operation h of job j on machine i; idleᵢ denotes the idle time of machine i after job assignment; pᵢⱼₕ denotes the power consumption rate of operation h of job j on machine i.
(3) Prediction-and-selection-based weight adjustment
Initialize 6 policy-weight pairs [p, w] to form a policy-weight set [symbol] . The specific formula is as follows: [symbol]
={[p₁,w₁],[p₂,w₂], . . . ,[p₆,w₆]} (3)
Wherein, p is a single neural network decision model trained based on the Proximal Policy Optimization (PPO) algorithm. The input of each policy p is the environmental state s, and the output is the probability distribution of action a. Network parameters are adjusted to maximize the long-term reward function R(s, a). w=[ω₁, ω₂] is a weight set. During reinforcement learning training, the reward functions described in Formulas (1) and (2) are combined in a linear weighting manner according to weights ω₁ and ω₂ in the weight set w. The specific formula is as follows:
R(s,a)=ω₁R_{MS}+ω₁R_{E} (4)
When the weight update moment is reached, adaptively update each weight. The update method includes the following sub-steps:
\textcircled{1} Generate candidate weights
For each policy-weight pair, set an angle range around the current weight direction θ=arccos (ω₁)±45°. Within the angle range, generate a series of candidate weight vectors at intervals of 2°:W={[cos(θ₁), sin(θ₂)], [cos(θ₁), sin(θ₂)], . . . , [cos(θₙ), sin(θₙ)]}, and add all nonnegative weights to the candidate policy-weight set [symbol] .
\textcircled{2} Predict target values
Adopt a regularization-based hyperbolic tangent fitting method to model the variation law of target values corresponding to candidate weights, and obtain model parameters through least squares optimization. First, normalize the candidate weights so that the sum of each component is 1. Then, obtain target value data, candidate weight data, and target variation data through the data acquisition module to construct training samples {xᵢ, yᵢ}, where xᵢ denotes the value of the candidate weight in a certain target dimension, and yᵢ denotes the corresponding target variation. Meanwhile, generate a weight factor wᵢ for each sample using a Gaussian function, where the default value of the scale parameter o of the Gaussian function is 0.03, and the initial search threshold is 0.1. If the collected valid data points are insufficient, gradually increase the search threshold and adjust the o value until a sufficient number of valid data are obtained. Construct the hyperbolic tangent model:
$$f ( x ; A , a , b , c ) = \frac{A ( {e}^{a ( x - b )} - 1 )}{{e}^{a ( x - b )} + 1} + c \qquad ( 5 )$$
Wherein, A, a, b, and c are model parameters, and the initial parameter vector is set to [1, 1, 1, 1]. Define the loss function as:
$${L}_{hb} = {\sum }_{i} {[ f ( {x}_{i} ; A , a , b , c ) - {y}_{i} ]}^{2} \cdot {w}_{i} + β \cdot \frac{{A}^{2} + {a}^{2} + {b}^{2} + {c}^{2}}{\vert r \vert} \qquad ( 6 )$$
Wherein, β is the regularization coefficient with a default value of 0.01; |r| denotes the norm of the residual vector. The parameter boundaries are set as follows: A ∈ [0, A_{upperbound}] (where A_{upperbound} is the difference between the maximum and minimum values of all yᵢ, clipped to the range of 1.0 to 500.0), a ∈ [0,20], b ∈ [−5,5], and c ∈ [−500,500].
Adopt the least squares optimization algorithm to minimize the loss function L_{hb} using the soft L1 loss function and a scaling factor f_{scale}=20. Update parameters using the gradient descent method, and the update formula is as follows:
$$θ ← θ - η \frac{\partial {L}_{hb}}{\partial θ} , θ ∈ \{ A , a , b , c \} \qquad ( 7 )$$
Wherein, the learning rate n has a default value of 1×10⁻³. The iteration continues until the change in the loss function is less than the preset threshold ∈=10⁻⁶ or the maximum number of iterations Nₘₐₓ=1000 is reached, and finally the optimal parameter combination (A*, a*, b*, c*) is obtained.
Using the above optimal parameters, predict the target variation corresponding to the test weight through the model f(x; A*, a*, b*, c*), and then add the predicted variation to the current target value to obtain the predicted target value Ôₜ₊₁ of the candidate weight in the next training round.
\textcircled{3} Select optimal policy-weight pairs
For each candidate policy-weight pair [p, w] generated in \textcircled{1}, screen them through the comprehensive metric [symbol] ( [symbol] ) based on the target value Ôₜ₊₁ predicted in step \textcircled{2}. The formula for the comprehensive metric is as follows: [symbol]
( [symbol] )=HV( [symbol] )+400·IE( [symbol] )−S( [symbol] ) (8)
Wherein, HV( [symbol] ) is the hypervolume indicator reflecting the quality of the candidate set CS; IE( [symbol] ) is the information entropy indicator reflecting the uniformity of the candidate set CS; S( [symbol] ) is the sparsity indicator reflecting the sparsity of the candidate set [symbol] . Their calculation formulas are as follows:
$$HV ( 𝒞𝒮 ) = {\sum }_{k = 1}^{\vert 𝒞𝒮 \vert - 1} {\prod }_{l = 1}^{M} ( {\tilde{𝒞}}_{l}^{ref} - {\tilde{𝒞}}_{l} ( k ) ) \qquad ( 9 )$$
Wherein, | [symbol] | is the number of policy-weight pairs in the policy-weight set [symbol] ; M is the number of targets;
$${\tilde{𝒞}}_{l}^{ref}$$
is the component of the reference point (0,0) in the l-th target; [symbol] (k) is the value of the k-th candidate solution in the l-th target component.
$$IE ( 𝒞𝒮 ) = - {\sum }_{l = 1}^{\vert 𝒞𝒮 \vert - 1} p ( {\tilde{𝒞}}_{l} ) log p ( {\tilde{𝒞}}_{l} ) \qquad ( 10 )$$
Wherein, p( [symbol] ) denotes the proportion of target values in the candidate set [symbol] that fall into the l-th segment. The target value range is divided into 10 equal parts, and the number of policies in each part is counted to obtain the proportion of each part.
$$S ( 𝒞𝒮 ) = \frac{1}{\vert 𝒞𝒮 \vert - 1} {\sum }_{k = 1}^{\vert 𝒞𝒮 \vert - 1} {\sum }_{l = 1}^{M} {( {\tilde{𝒞}}_{l} ( k ) - {\tilde{𝒞}}_{l} ( k + 1 ) )}^{2} \qquad ( 11 )$$
Wherein, [symbol] (k+1) is the value of the (k+1)-th candidate solution in the l-th target component.
From the 18 candidate policy-weight pairs, select the top 6 pairs with the highest mutual information I(W;O) between candidate weights and target values to form the final policy-weight set. The calculation formula is as follows:
$$I ( W ; O ) = {\sum }_{i = 1}^{6} p ( {w}_{i} , {O}_{i} ) log \frac{p ( {w}_{i} , {O}_{i} )}{p ( {w}_{i} ) p ( {O}_{i} )} \qquad ( 12 )$$
Wherein, W=[w₁, w₂, . . . , w₆] denotes each candidate weight vector; O=[O₁, O₂, . . . , O₆] denotes the target vector.
(4) Model training and optimization
Initialize the 6 weight sets w at intervals of 0.2 as w₁={[1,0]}, w₂={[0.8,0.2]}, w₃={[0.6,0.4]}, w₄={[0.4,0.6]}, w₅={[0.2,0.8]}, W₆={[0,1]}, and form the policy-weight set [symbol] with 6 randomly initialized policies p.
In the pre-training phase, perform reinforcement learning training on each policy p for 20 rounds using fixed weights.
In the main training phase, perform reinforcement learning training on each policy p in the policy-weight set [symbol] , and dynamically update the policy-weight set every 10 rounds using the method described in (3) to adjust the weights used in the reward function of each policy.
When the total number of training rounds reaches 100, extract all policies with an average reward not less than 90% of the historical maximum reward from the training results of the last round (the 100th round) to obtain the policy set p=[p₁, p₂, . . . , p_{q}], where q is the number of finally obtained policies, and the job shop scheduling policy training is completed.
